(19) United States
(12) Patent Application Publication
(10) Pub. No.: US 2011/0001369 A1
(43) Pub. Date: Jan. 6, 2011

(54) Quiet blender

(76) Inventor: Abel Dayer LeBaron, JR., Elpaso, TX (US)

Correspondence Address: Abel D. LeBaron, 593 Knollwood Ln., Elpaso, TX, 79932, US

(21) Appl. No.: 12/459,601

(22) Filed: Jul. 6, 2009

(51) Int. Cl. H02K 5/24

(52) U.S. Cl. 310/51

(57) ABSTRACT

The present invention relates generally to loud disturbing noise accompanied with uncontrollable vibrations and, sound wave vibrations made from electric motor appliances such as blenders. Abstract: An electric motor design housing, filled with qualified sound deadening and temperature absorbing material, where in this case, the small electric motor of a blender operates in said invention, which is a designed motor housing filled with qualified sound deadening and temperature absorbing material, greatly reducing noise and vibration when appliance is used in operation mode.

### BACK GROUND OF PRESENT INVENTION

Obnoxious, disturbing noise and vibration cause from the operation of electric motor appliances, such as blender. Such noise is unacceptable to the user of the appliance, who may operate said appliance, as well as in a home kitchen, as in commercial environment, like restaurante's etc.

Present known blenders provide no attempt whatsoever to deaden the irritating sound, as described in Prior art . . . Forward→Designed motor housing filled with qualified sound deadening material, operate motor in submerged housing

### SUMMARY OF THE INVENTION

Now, the objection of present invention is to fill described designed small motor housing, with qualified sound deadening and temperature absorbing soft sell material, wherein motor's submerged into the former, and thereby operates in said housing which takes to greatly reducing sound and vibrations.

### BRIEF DESCRIPTION OF DRAWINGS

FIG. 1 Shows a blender 27, complete with motor housing 1, where the blender jar 14 is mounted onto the motor housing 1, with jar lid 18, also sows lid plug measuring cup. 13, and blender tamper 8.

FIG. 2 Shows a transparent view of motor housing 1, depicting the essence of the said invention compartments of the designed motor housing.

FIG. 3 Is an exploded view of the designed motor housing 1.

FIG. 4 Further shows a transparent view of designed motor housing 1, as it should be filled with sound deadening material depicted by reference num. 2,

FIG. 5 Is a complete transparent view of a blender including its needed parts and necessary compartments to fully function, whereby said invention is incorporated into appliance motor housing, which has hereto therefore been proven to greatly deaden sound and vibrations, and sound wave vibrations.

FIG. 6 shows multiple views of a blender in a three step assembly line, to incorporate said invention into small motor appliance (blender). FIG. 3a Motor housing which is the said Invention, in an exploded view. FIG. 2b Design motor housing as is with incorporated new improved sound deadening invention. FIG. 1c Blender ready for full function, now with greatly reduced noise and vibration at any given time

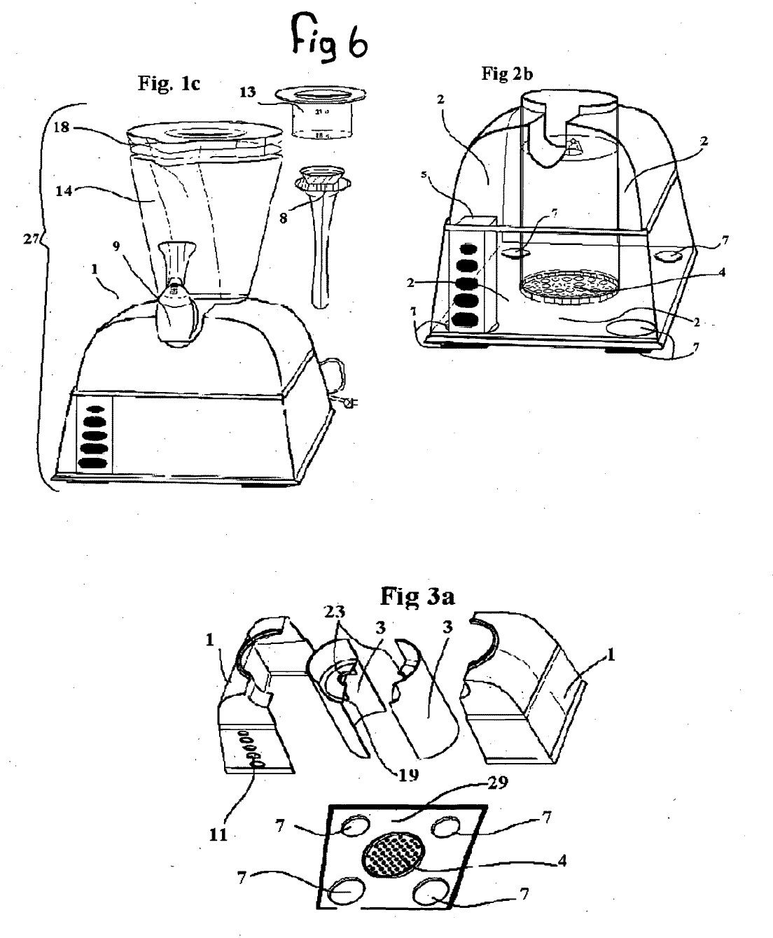

### DETAILED DESCRIPTION OF PREFERRED EMBODIMENTS

In the forward, detailed description pertaining to present invention, will be handled to put forth and effort in providing the new concept, not formerly practice in prior small appliances to deaden sound and vibrations. Accordingly, the specific presentation disclosed structure, should not be a reasonable limitation of the scope, for the entire present invention . . . Forward→ . . . .

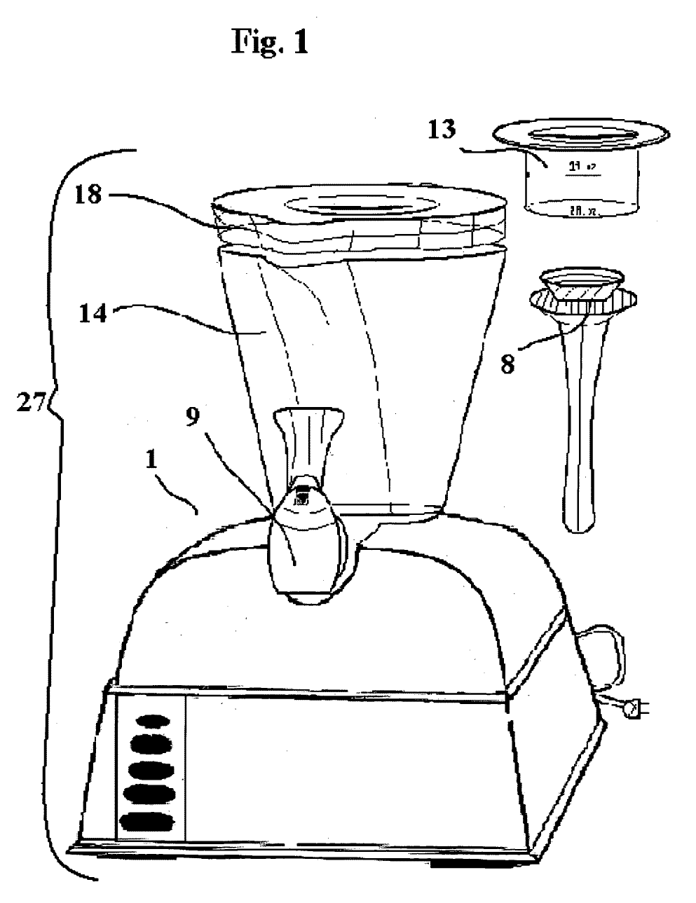

In FIG. 1 is shown a blender 27 with its blender jar 14 mounted to the design motor housing 1, the blender jar is accompanied thereto with its jar lid 18, blender tamper 8, and jar lid plug measuring cup 13. Attached to jar is dispensing spout 9. Hereto therefore, FIG. 1 is depicting blender kitchen appliance, with said invention incorporated thereunto in a ready to function state of the prior art . . . .

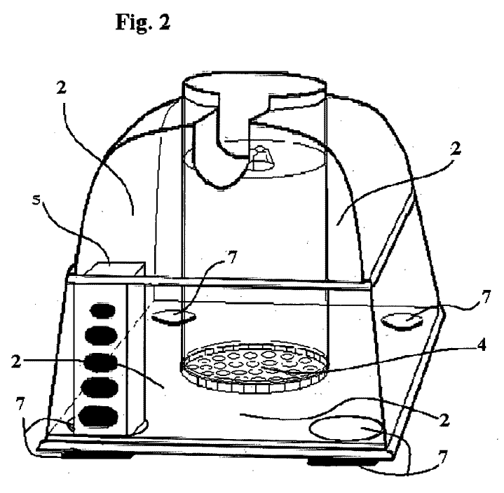

Further now, referring to FIG. 2 which shows a transparent view of the design motor housing 1 with its compartments in a clearer perception. Reference num. 2 depicts multiple examples of area, wherein sound deadening and temperature absorbing material is injected describing the first principle of said invention, which in this case said blender appliance 27 is cost effectively filled and insulated with a silicone mixture. Yet it is to be noted that there are many sound deadening materials that can equally fill the design motor housing to have a great or greater effect, leaving the concept of said invention to remain the same. Reference num. 3 points to the submerged motor chamber 3, which in this case, motor chamber 3 is attached to a temperature vent 4, the function of motor chamber 3 will be further described in detail. But at this point, reference num. 5 depicts the speed switch button cabinet, and ref. num. 7 are the design motor housing support legs.

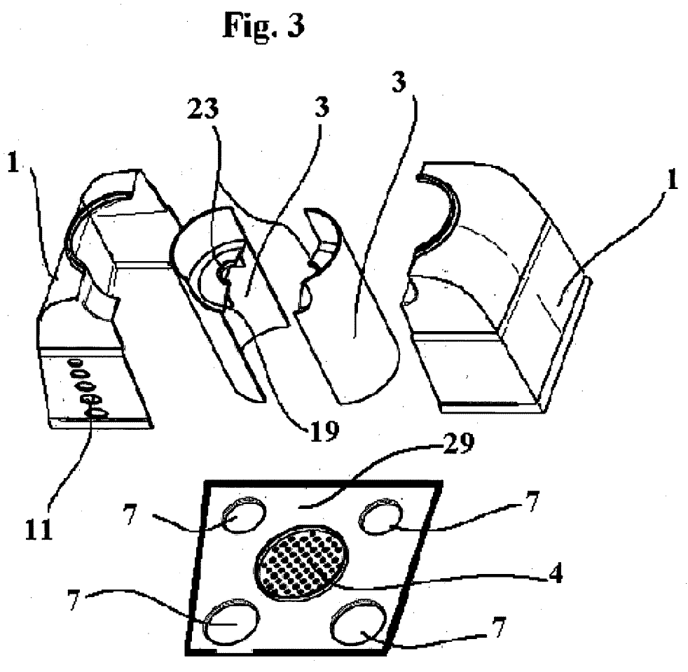

referring to FIG. 3 which is an exploded view of design motor housing in its former compartments. Reference num. 1 as already stated is the entire scope of the design motor housing, and ref. num. 11 are the speed switch buttons, ref. num. 29 is the bottom lid of design motor housing, with temperature vent 4, and motor housing support legs are depicted by ref. num. 7. Reference num. 3 points to the motor chamber. Ref. num. 19 depicts the small appliance motor mount, and num. 28 is the hole where small motor shaft meets the sprocket, and 28 is where sprocket sits, to be turned at high rpm by appliance motor. Take the referring reference num. 1 left and right, num. 3. left and right, and bottom lid ref num 29. When these three 1, 3, and 29 with there certain compartments, are injection molded with ABS material wherewith coupled together, they will form the complete design motor housing, what is the subject of the present invention.

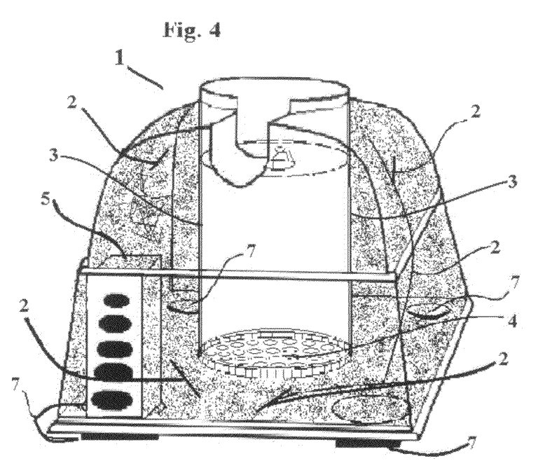

Moving on to FIG. 4 in which, FIG. 4 is mostly trying to relate the concept of the present invention, in where, the design motor housing is filled with sound deadening and temperature absorbing material what is pointed out in multiple areas by ref num. 2 also as already said, ref. num 3 is the submerged motor housing, ref. num. 4 is the temperature escape vent, ref. num 5 points to the speed switch button cabinet, and ref. num. 7 are the design motor housing support legs. And ref. 1 is of course the design motor housing.

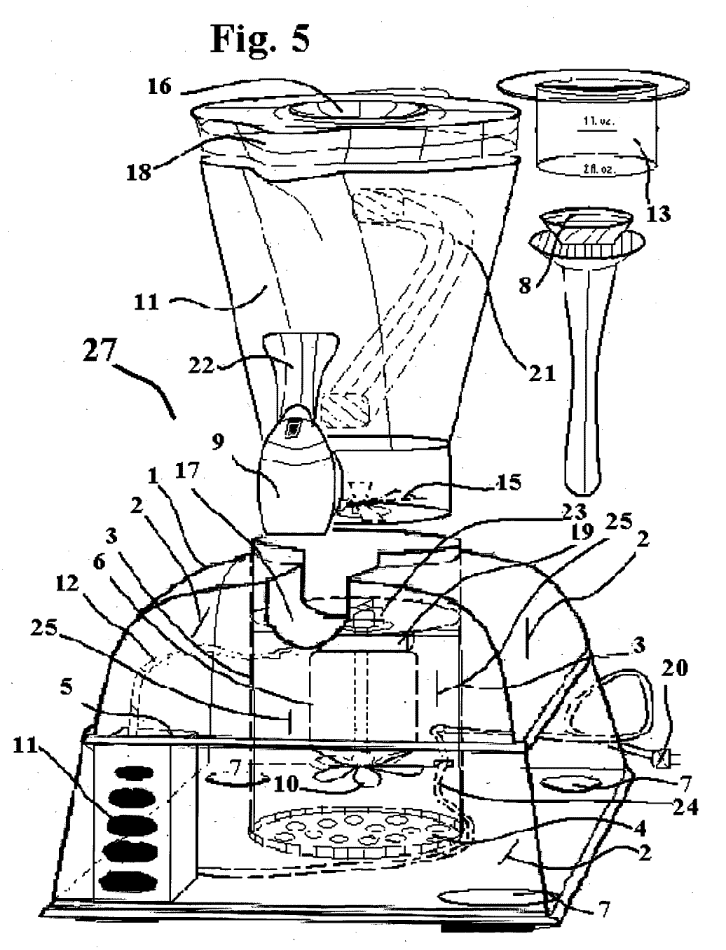

Now lets forward on to FIG. 5, wherein FIG. 5 presents a transparent view of the full embodiment of a blender, 27, with all its needed attachments and necessary compartments, to function properly, if built as described, is proven to greatly reduced sound noise, and vibrations what has been the problem needed to be solved for decades, and the problem of sound and vibrations has been sought after to be solved for the betterment of society, and on various different occasions solving this problem has been attempted, like the attempt to muffle the sound noise; there has been three attempts by different inventors who worked on the concept of muffling sound, which were good ideas with great effort, but these attempts have had only little success because of the lack of simplicity, and not being able to totally solve the problem. Also among quite a few different attempts to solve the said problem of disturbing noise and vibration produced from the operation of a blender, was the attempt to “housing” the entire appliance by Haushalter et al, who succeeded to obtain a U.S. Pat. No. 4,883,144, but this was way back in 1989 . . . . The Idea was very good too but in many ways inconvenient, and probably expensive as well. So, in FIG. 5, which is a transparent view of entire blender appliance 27, with the concept of the present invention incorporated into it, which is . . . . A design motor housing 1, filled with qualified sound deadening and temperature absorbing material 2. Now moving on from hereto therefore, the different ref. numbers below are described in further detail but note that some of the below references are only tools and accommodations to better the present inventions appearance and function. And there can be many more such tools and accommodations grafted into said invention for the betterment of it, without falling out of the scope of the said invention. Num. 1 is the design motor housing, while, ref. num. 2 shows multiple points where sound deadening material is incorporated into the design motor housing. Actually the sound deadening material fills all empty space inside of design motor housing. Ref num 3 again, is the submerged motor chamber in which from the motor mount 19, hangs the appliances small motor 6, whose motor shaft is locked into sprocket 23, which sets securely in the hole 26. Motor mount 19, is the main support for the small motor 6 what in this case dose use a fan 10. The fan 10 is a smaller then what has normally been used by other blenders, and thereby produces quieter noise, yet still effective. Fan 10 will not always be necessary, as the scope of the invention is to completely reduce the sound noise made from small motor appliances such as blenders. Thereby ref. num. 25 shows in this example empty space what leaves motor chamber 3 capable to be filled with qualified sound deadening and temperature absorbing material, when this is done, the scope of this invention is complete, creating the Quiet Blender. In whatever case, the temperature escape vent 4 would always be used. Ref. num. 5 is the speed switch button cabinet, 11 is the speed switch buttons, 12 is interior wiring, 6 depicts small motor, 10 motor fan, 19 is the motor mount, 23 is the sprocket what is locked on to the motor shaft, 26 is hole where sits the sprocket 23 and through which passes the motor shaft, ref. num 7 are the design motor housing support legs, ref. num. 24 depicts the interior power cord, 20 is the cord power plug, ref. num. 17 shows the design motor housing notch what leaves a place for spout dispenser num. 9 when blender jar 14 is mounted on to the design motor housing 1, Ref. num. 22 is the spout dispense lever and ref. num. 15 is the mixing blades. Ref. num. 14 is blender jar, and ref. num. 21 is the blender jar handle, and ref. num. 16 is the jar plug and blender tamper hole. The blender tamper is depicted by ref. num. 8, and ref. num. 13 points to the new and improved blender jar, lid plug, measuring cup . . . .

While present invention has been described with reference to specific embodiments thereof, it should be noticed that many variations and modifications and additional embodiments are possible, all such variations and embodiments are to be regarded as being within the sprint and scope of present invention, hereto and therefore.

What is claimed:

1. Said claim 1—A design motor housing for small electric appliances, filled with sound deadening and temperature absorbing material, wherein small electric motor operates while is submerged along with it compartments into the qualified sound deadening material. Wherefore motor housing is adapted into said appliance, and said appliance operates with greatly reduced sound.

2. Said claim 2—A design small electric motor chamber 3, which is grafted into said claim 1 Appliance motor housing, by submerging motor chamber 3 into design motor housing of said claim 1, to create a complete small electric motor housing with motor chamber compartment.
The small electric motor 6 hangs from motor mount 19, and thereby locks on to sprocket 23. When appliance motor 6 operates in said appliance design motor chamber 3, which is submerged into design motor housing 1, and both motor housing and motor chamber are filled with sound deadening and temperature qualified material, the scope of the present invention will be cleared, and thereby greatly reduce sound noise, absorbing temperature, and eliminating vibrations of small appliances such as blenders, and making society happier.

3. Said claim 3 removes vibration produced from the operation of, electrical motor appliances, when the interior of the design motor housing is filled with qualified sound deadening and temperature absorbing material establishing sufficient weight for the subject in matter, to greatly eliminate vibration and sound wave vibrations.
